(19) United States
(12) Patent Application Publication
(10) Pub. No.: US 2017/0175442 A1
(43) Pub. Date: Jun. 22, 2017

(54) COMBINATION HANDLE AND LOCK FOR A STEP LADDER

(71) Applicant: Paul E. Myers, Statesville, NC (US)

(72) Inventor: Paul E. Myers, Statesville, NC (US)

(21) Appl. No.: 14/974,048

(22) Filed: Dec. 18, 2015

(51) Int. Cl. E06C 7/00; E05B 65/00

(52) U.S. Cl. CPC E06C 7/00; E05B 65/00; E06C 1/383

(57) ABSTRACT

A handle portion and a locking element are combined in a mounting member on one leg of a ladder with the handle at or near the longitudinal center of gravity of the ladder for ease of carrying the ladder with one hand. The mounting member has a recess facing the other leg of the ladder, on which another mounting member is attached with a projection that seats in the recess when the legs of the ladder are in closed non-use position. The first mounting member and the projection have apertures that are aligned when the projection is in the recess. The projection is locked in the recess by the insertion of a pin of a push-pin locking element, and which pin can not be retracted to unlock the legs for use of the ladder without a key, thus unauthorized use of the ladder is prevented.

The present invention is directed to a combination handle and lock for a step ladder, and, more particularly, to a combination handle and lock for a step ladder that provides for locking the legs of a step ladder together in a closed position with a lock operated by a removable key to prevent unauthorized use of the step ladder, and includes a handle for substantially balanced carrying of the locked step ladder.

### BACKGROUND OF THE INVENTION

A combination handle and lock for a step ladder is disclosed in U.S. Pat. No. 6,390,238 and its continuation patent, U.S. Pat. No. 7,370,727. However, the lock of these patents is complicated and unwieldy, and does not provide for preventing unauthorized opening of the legs of the step ladder.

One of the problems in using step ladders, particularly at job sites where there are different workers from the same or different entities, is that ladders are often left at a worksite unattended for some period of time, and someone else in need of a ladder takes the idle ladder to use at a different location, and, either intentionally or unintentionally, fails to return it when it is needed by the original user.

### SUMMARY OF THE INVENTION

The present invention provides a lock that has components on both legs of a step ladder, which components abut each other when the legs are closed and are locked together using a removable key so that the step ladder is rendered useless until the key is reinserted, with the result that, if the ladder is left unattended, it is not likely that someone else needing a ladder will take it away or, if they do, they may return it promptly. In the preferred embodiment the lock is combined with a handle, and the lock is positioned on the ladder with the handle component in position for the handle to be sufficiently aligned with the lengthwise center of gravity of the ladder. Thus, the combination of the closed and locked ladder and the location of the handle maintaining the ladder closed provides substantial balance of the locked ladder for ease of carrying the ladder with one hand.

In a preferred embodiment, the combination handle and lock is attached to the outer side surfaces of the adjacent side rails of the legs of the step ladder. A first mounting member of the ladder is attached to the outer side surface of one of the rails of one leg and projects laterally outwardly. The first mounting member has a handle portion sufficiently aligned with the lengthwise center of gravity of the ladder for substantially balanced carrying of the ladder with one hand grasping the handle.

A second mounting member is attached to the outer side surface of one of the rails of the second leg in abutting alignment with the first mounting member when the legs of the ladder are closed in a non-use position. A first of the mounting members has a recess extending from an opening facing the second of the mounting members, which second mounting member has a projection located and shaped to be received in the recess of the first locking member when the legs are closed in abutting relationship when the ladder legs are in a closed non-use position.

The first mounting member, which has the recess therein, has a laterally extending aperture opening into the recess and the projection on the second mounting member has a laterally extending aperture, with the apertures being in alignment when the rails are abutting and the projection is in the recess.

A locking element is seated in the aperture of the first mounting member and is retractably extendable into the aperture in the projection of the second mounting member to lock the ladder legs together. The locking element is operated by a removable key to extend into the aperture in the projection to lock the legs in their closed non-use position so that the legs cannot be spread apart for use of the ladder without use of the key, thereby preventing unauthorized use of the ladder and discouraging the taking of the ladder by someone that does not have the key. Preferably, the lock is a conventional push-pin lock that has a pin retractably extendible into the aperture in the projection to lock the legs together and which can be retracted to open the lock only by use of the key, so that the locked ladder can not be used until the key is reinserted.

Preferably, one of the legs of the ladder has rungs for climbing, which is, therefore, the front leg of the ladder. The first mounting member, which is the mounting member with the handle, is mounted on the front leg, with the rungs and the handle resulting in the front leg of the ladder bring the heavier of the legs. This contributes to the ladder being latterly balanced when carried by the handle by one hand.

### BRIEF DESCRIPTION OF THE DRAWINGS

FIG. 1 is a side perspective view of the preferred embodiment of the combination handle and lock attached to one type of conventional step ladder with the legs of the ladder locked in a closed position;

FIG. 2 is a side elevational view of the preferred embodiment of the combination handle and lock of FIG. 1 attached to another type of conventional step ladder with the combination handle and lock unlocked and the legs of the step ladder spread open in position for use;

FIG. 3 is an enlarged partial view of the portion of FIG. 2 with the legs of the step ladder closed in non-use position and the combination handle and lock in locked position;

FIG. 4 is a view similar to FIG. 3 with the key of the lock inserted in the lock element;

FIG. 5 is an enlarged perspective view of the embodiment of FIG. 2 showing the legs of the step ladder partially spread and the lock open;

FIG. 6 is an enlarged perspective view of the leg of the step ladder of FIG. 2 that has the mounting member of the lock with the projection thereon;

FIG. 7 is an enlarged perspective view of the leg of the embodiment of FIG. 2 that has the mounting member of the lock with the recess therein, and illustrating the pin of the locking element in retracted unlocked position;

FIG. 8 is a view similar to FIG. 7 and showing the pin of the locking element extended in locking position;

FIG. 9 is an exploded perspective view of the components of the embodiment of FIG. 3;

FIG. 10 is a view similar to FIG. 9 as viewed from a different angle;

FIG. 11 is a side elevational view of the locking element of the embodiment of FIG. 2 with the pin of the locking element in extended locking position;

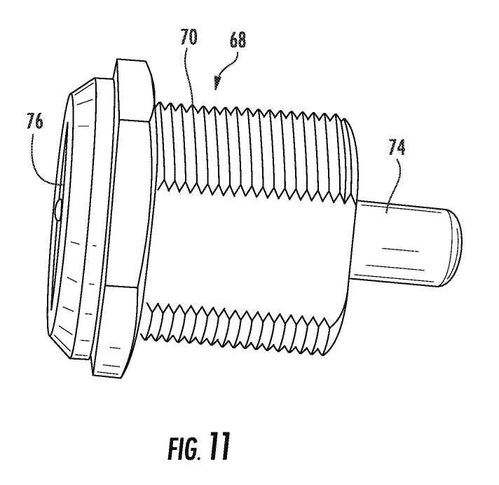

FIG. 12 is a view similar to FIG. 11 with the pin of the locking element retracted in unlocked position, and showing keys for operating the locking element; and

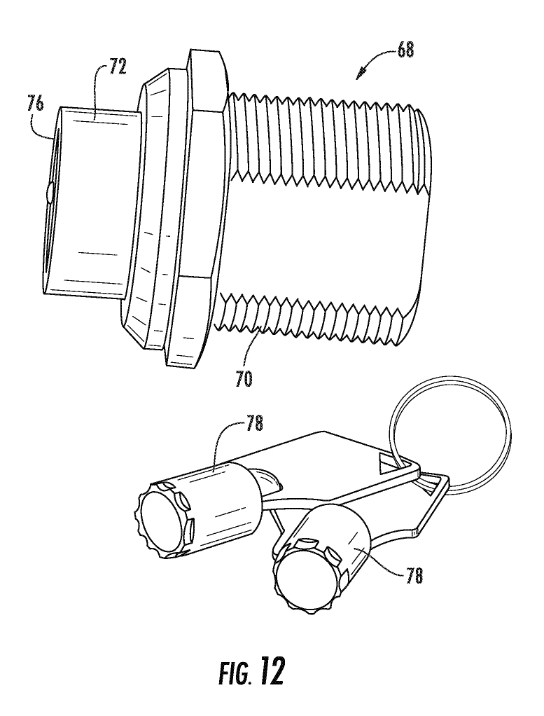

FIG. 13 is a perspective view of the step ladder of FIG. 2 shown being carried by one hand of a person.

### DETAILED DESCRIPTION OF THE PREFERRED EMBODIMENT

Following is a detailed description of the preferred embodiment of the present invention described with reference to the accompanying drawings.

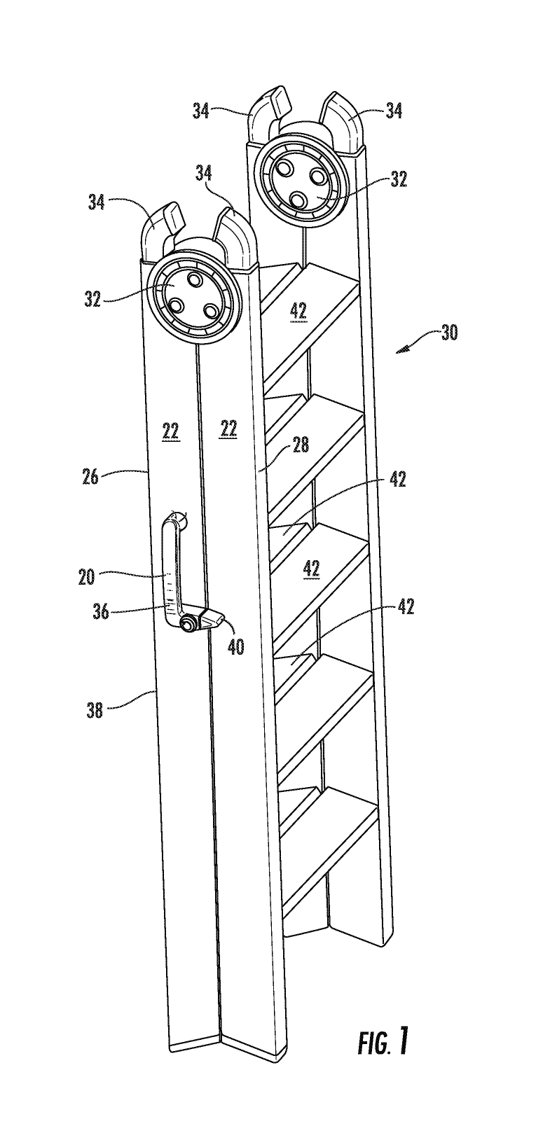

The combination handle and lock 20 of the preferred embodiment of the present invention is illustrated in FIG. 1 attached to and projecting laterally outwardly from the outer side surfaces 22 of first rails 24 of each leg 26, 28 of a representative type of step ladder 30, with the legs 26, 28 illustrated abutting in a closed non-use position. The legs 26, 28 are pivoted about a pivot mechanism 32 at their upper ends, with the legs having projections 34 at their upper ends that abut when the legs are opened to stop the legs in a spread open use position. The combination handle and lock 20 has a first mounting member 36 attached to and projecting laterally outwardly from the outer side surface 22 of the first rail 38 of one of the legs 26, and a second mounting member 40 attached to and projecting laterally outwardly from the outer side surface 22 of the first rail 38 of the second leg 28. The mounting members 36, 40 are aligned for engagement and locking together when the ladder legs 26, 28 are in the closed non-use position illustrated in FIG. 1.

The first mounting member 36 has a handle portion 42 projecting laterally outward and sufficiently aligned with the lengthwise center of gravity of the ladder for substantially balanced carrying of the ladder with one hand. The ladder 30 of FIG. 1 has rungs 44 extending between the rails 24 on each leg 26, 28 with the result that it makes no significant difference in the lateral balance of the ladder when carrying by the handle portion whether the handle portion 42 is attached to one or the other leg 26,28.

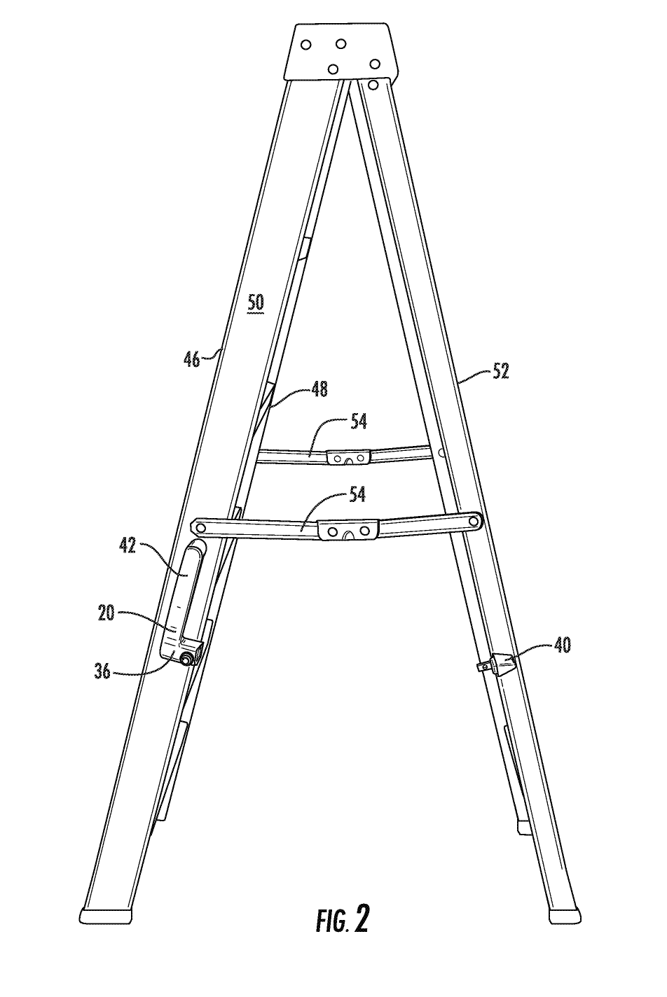

The combination handle and lock of the present invention can be used to advantage in various forms of step ladders in addition to the step ladder 30 of FIG. 1. In this regard, FIGS. 2 through 5 and 13 illustrate the combination handle and lock 20 of the preferred embodiment illustrated in FIG. 1 attached to a conventional step ladder 44, that has a front or first leg 46 that has rungs 48 extending between and secured to the first and second rails 50 of the front leg 46, and no rungs attached to the rails 50 of the rear or second leg 52. With this form of step ladder 42 the legs 46, 52 are positioned and held in an open use position by conventional releasable links 54. As the rungs 48 add weight to the front leg 46 and as the front leg 46 is otherwise heavier than the rear leg 52, it is advantageous for balance when carrying the ladder 44 to attach the mounting member 36 with the handle portion 42 on the front leg46, as illustrated in FIGS. 2 through 5 and 13.

The mounting member 36 having the handle portion 42 has a recess 56 formed therein that extends generally perpendicular to the leg 46 on which it is attached, from an opening 58 facing the other mounting member 40 when the legs 46, 48 are closed, and the other mounting member 40 has a projection 60 that extends generally perpendicular to the length of the leg 46 on which it is attached. The projection 60 is located and shaped to be received in the recess 66 of the first mounting member 36 when the legs 46, 52 are in abutting closed position.

The mounting member 36 having the recess 56 has a laterally extending aperture 62 extending from its outer surface 64 and opening into the recess 56, and the projection 60 on the other mounting member 40 has a laterally extending aperture 66 which aligns with the aperture 62 in the first mounting member 36 when the rails 50 of the legs 46, 52 are abutting in closed non-use position.

A locking element 68 is insertable into the aligned apertures 62, 66 to lock the legs 46, 52 in closed non-use position. Preferably, the locking element 68 is a conventional push-pin locking element that has a housing 70 seated in the aperture 62. A plunger member 72 is slidable in the housing 70, and has a pin 74 at its inner end extending inwardly for extension into and retraction out of the recess 56. The plunger member 72 reciprocates from an unlocked position in which its outer end 76 extends outwardly beyond the aperture 62, and the pin 74 is retracted from the recess 56, permitting free movement of the projection 60 on the other mounting member 40 in and out of the recess 56. Pressing the outer end 76 of the plunger member 72 in, when the projection 60 is in the recess 56 with the legs 46, 52 closed, causes the pin 74 to enter the recess 56 and into the aperture 66 in the inserted projection 60, thereby locking the mounting members and the legs to which they are attached in the closed non-use position. With the conventional push-pin locking element 68, once the plunger member 72 has been pushed in and the pin 74 is in the aligned apertures 62,66 locking the legs 46, 52 together, retraction can occur only by inserting a key 78 in the outer end 76 of the plunger member 72 and rotating the key 78 to allow the plunger member 72 to retract and retract the pin 74 from the aperture 66, freeing the projection 60 for removal from the recess 56. With this arrangement, once locked the legs 46, 52 can not be opened without using the key 78, rendering the ladder unusable by anyone who does not have a key

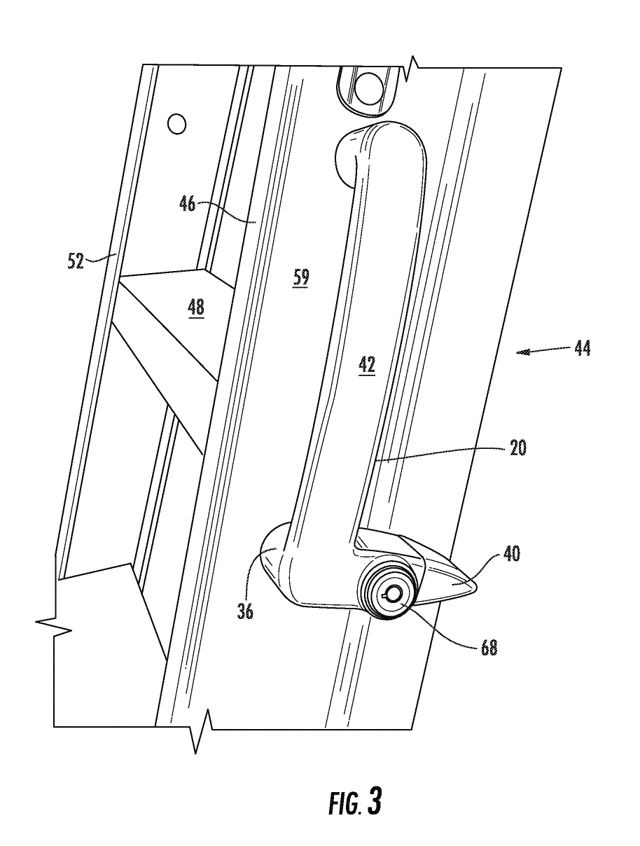

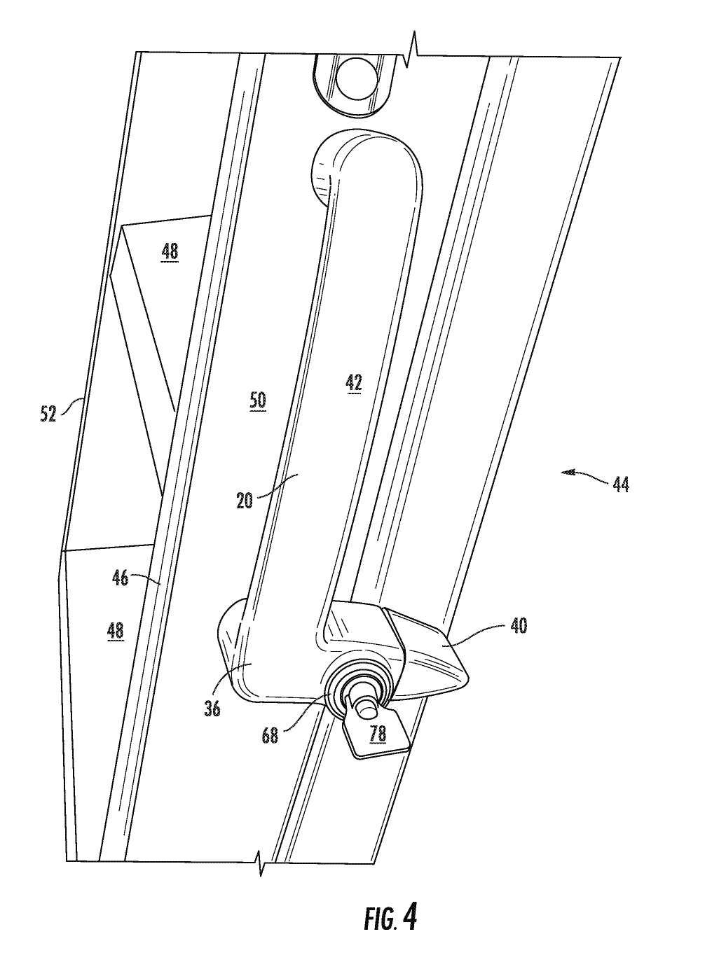

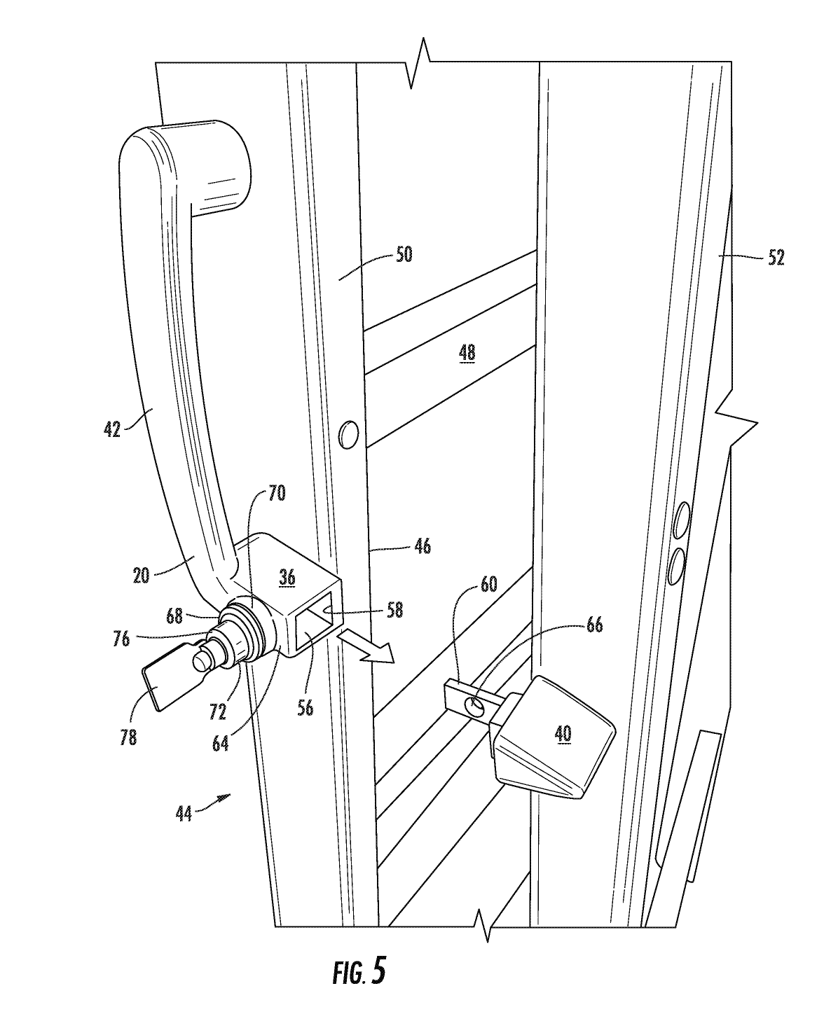

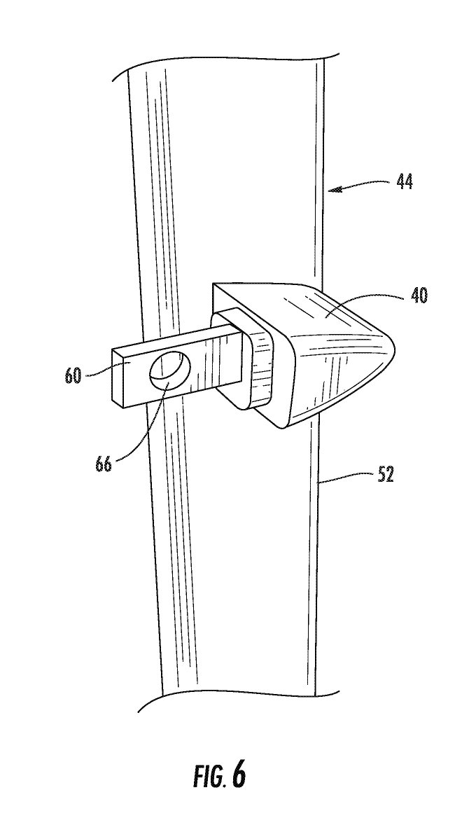

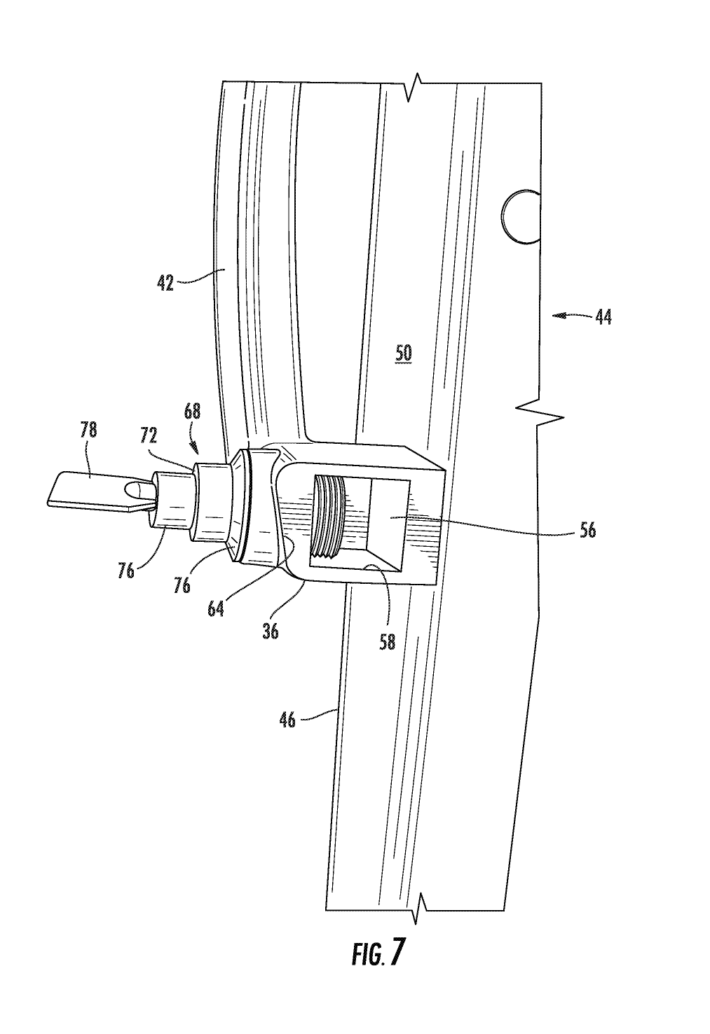

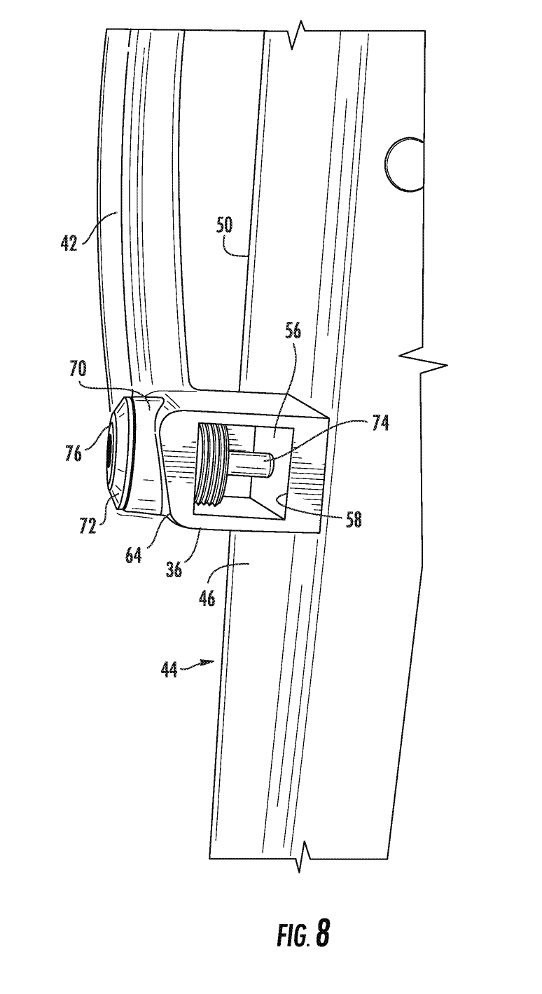

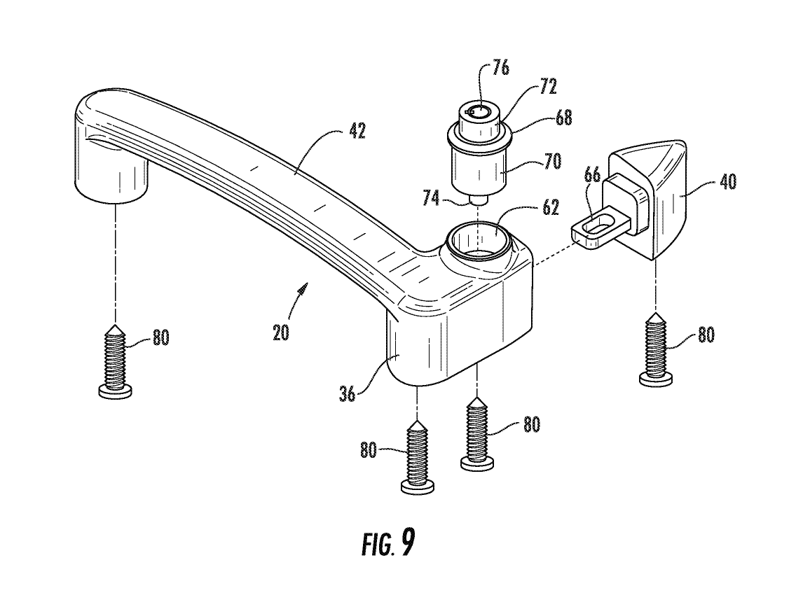

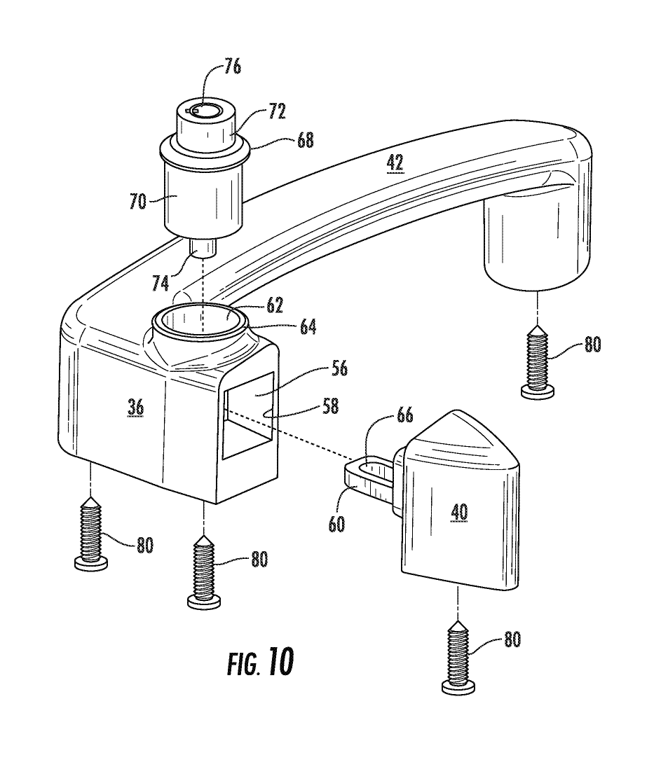

The locked position of the combination handle and lock 20 of the preferred embodiment of the present invention is illustrated in FIG. 3, in which the legs 46, 52 of the ladder 44 are locked together with the plunger member 72 and pin 74 is in locked position. FIG. 4 illustrates the locked condition with the key 78 inserted preparatory to unlocking. FIG. 5 illustrates the key 78 having unlocked the locking element 68, allowing the pin 74 to retract out of the aperture 66 in the projection 60, and showing the legs 46, 52 separated. FIG. 6 illustrates the mounting member 40 that has the projection 60 and illustrates the aperture 66 that is in the projection 60. FIG. 7 illustrates the unlocked condition of the locking element 68, with the plunger member 72 retracted, the pin 74 retracted, and the key 78 in the plunger member 72. In this unlocked condition the projection 60 on the mounting member 40 can be inserted into or withdrawn from the recess 56. FIG. 8 shows the locking element 68 with the plunger member 72 having been pushed into the locking position with the pin 74 extending into the recess 56 as it would be if the projection 60 on the mounting member 40 had been inserted in the recess. FIGS. 9 and 10 are exploded views of the parts of the combination handle and lock 20,

With this combination handle and lock of the present invention, no one without a proper key 74 for the push-pin locking element 68, can open the legs 46, 52 of the ladder 44 and render it usable. This substantially eliminates the common problem of unauthorized use of a step ladder that has been left unattended for a short period of time or overnight or for any other reason. Thus discouraging the unauthorized taking of the ladder by a coworker or by anyone else, such as an employee of another contractor at the same work site, borrowing the ladder for use at another location, knowing that it cannot be opened to a usable position.

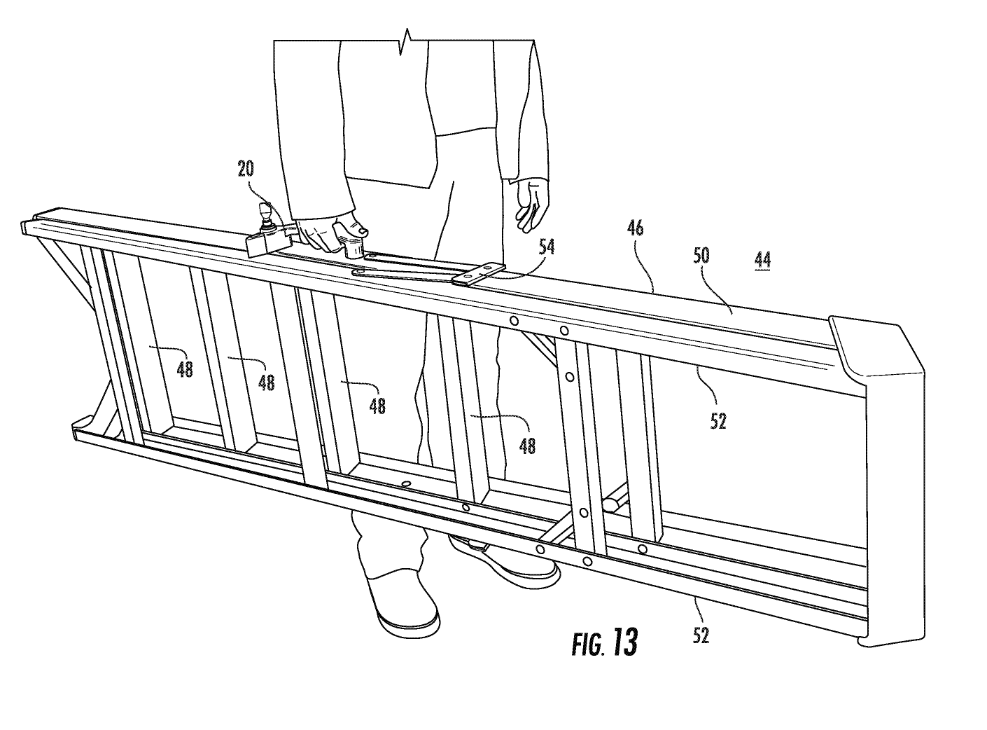

The combination of the lock with the handle facilitates the handling of the locked ladder with a compact structure in which the components are centrally located for balance in carrying a ladder, as illustrated in FIG. 13.. However, the simple and compact locking feature that requires a key for opening, thereby preventing unauthorized use of a ladder, even without a handle, is within the scope of the present invention.

The mounting members 36, 40 are attached to the legs 46, 52 of the step ladder in any suitable manner, such as with screws 80, bolts or any other conventional means. Alternatively, the combination handle and lock 20 can be provided unattached to a ladder for attachment to a ladder by someone else.

In view of the a forgoing written description and drawings of the present invention, it will be readily understood by those skilled in the art that the present invention is susceptible of broad utility and application in many embodiments and adaptations of the present invention other than those herein described. Many variations and modifications will be apparent from or reasonably suggested by the foregoing description without departing from the substance or scope of the present invention. Accordingly, while the present invention has been described herein in detail in relation to the preferred embodiment, it is to be understood that this disclosure is only illustrative of examples of the present invention and is made merely for purposes of providing a full and enabling disclosure of the invention. The foregoing disclosure is not intended nor is it to be construed to limit the present invention or otherwise exclude any other embodiment, adaptations, variations, modifications and equivalent arrangements, the present invention being limited only by the scope of the claims appended hereto and equivalents thereof.

1. A combination handle and lock for a step ladder that has a pair of legs, each leg having first and second side rails, said legs being pivotally connected for pivoting between a spread open use position and a closed non-use position, in which closed position the first and second side rails of one leg abut the first and second side rails of the other leg, and said rails have outer side surfaces, said ladder having a lengthwise center of gravity, said combination handle and lock comprising:
a first mounting member attached to the outer side surface of said first rail of said first leg and projecting laterally outwardly therefrom;
said first mounting member having a handle portion projecting laterally outward and sufficiently aligned with said lengthwise center of gravity of said ladder for substantially balanced carrying of the ladder with one hand;
a second mounting member attached to the outer side surface of said first rail of said second leg in abutting alignment with said first mounting member;
one of said first and second mounting members having a recess extending into said mounting member from an opening facing the other of said first and second mounting members;
the other of said first and second mounting members having a projection located and shaped to be received within said recess when said legs are abutting;
said one mounting member having a laterally extending aperture opening into said recess, and said projection having a laterally extending aperture, said apertures being in alignment when said rails are abutting; and
a locking element insertable into said apertures and operated by a removable key to lock said legs in said closed, non-use position.

2. The combination handle and lock for a step ladder according to claim 1, characterized further in that said locking element is a push-pin lock having a pin retractably insertable into said aperture of said projection to lock said mounting members and legs together in closed non-use position.

3. The combination handle and lock for a step ladder according to claim 1 wherein the ladder has rungs extending across said one leg and attached to the rails of said one leg, said combination handle and lock characterized further in that said handle is on said first mounting member that is attached to said one leg.

4. The combination handle and lock for a step ladder according to claim 3, characterized further in that said locking element is a push-pin lock having a pin retractably insertable into said aperture of said projection to lock said mounting members and legs together in closed non-use position.

5. A lock for a step ladder that has a pair of legs, each leg having first and second side rails, said legs being pivotally connected for pivoting between a spread open use position and a closed non-use position, in which closed position the first and second side rails of one leg abut the first and second side rails of the other leg, and said rails have outer side surfaces, said lock comprising:
a first mounting member attached to the outer side surface of said first rail of said first leg;
a second mounting member attachable to the outer side surface of said first rail of said second leg for abutting alignment with said first mounting member;
one of said first and second mounting members having a recess extending into said mounting member from an opening facing the other of said first and second mounting members;
the other of said first and second mounting members having a projection located and shaped to be received within said recess when said legs are abutting;
said one mounting member having a laterally extending aperture opening into said recess, and said projection having a laterally extending aperture, said apertures being in alignment when said rails are abutting; and
a locking element insertable into said apertures and operated by a removable key to lock said legs in said closed, non-use position.

6. The lock for a step ladder according to claim 5, characterized further in that said locking element is a push-pin lock having a pin retractably insertable into said aperture of said projection to lock said mounting members and legs together in closed non-use position.

7. The lock for a step ladder according to claim 5 wherein the ladder has rungs extending across said one leg and attached to the rails of said one leg, said lock characterized further in that recess extends into said first mounting member; and said projection is on said second mounting member.

8. The (combination handle and) lock for a step ladder according to claim 7, characterized further in that said locking element is a push-pin lock having a pin retractably insertable into said aperture of said projection to lock said mounting members and legs together in closed non-use position.

9. A combination handle and lock for attachment to a step ladder that has a pair of legs, each having first and second rails, said rails being pivotally connected for pivoting between a spread open use position and a closed non-use position, in which closed position the first and second side rails of one leg abut the first and second side rails of the other leg, and said rails have outer side surfaces, said ladder having a lengthwise center of gravity, said combination handle and lock comprising:
a first mounting member having a handle portion;
said first mounting member attachable to said first rail of said first leg with said handle portion sufficiently aligned with said lengthwise center of gravity of said ladder for substantially balanced carrying of the ladder with one hand;
a second mounting member attachable to the outer side surface of said first rail of said second leg for abutting alignment with said first mounting member when said mounting members are attached to the step ladder;
one of said first and second mounting members having a recess extending into said mounting member from an opening facing the other of said first and second mounting members when said mounting members are attached to said rails;
the other of said first and second mounting members having a projection located and shaped to be received within said recess when said mounting members are secured to said legs and said legs are abutting;
said one mounting member having a laterally extending aperture opening into said recess, and said projection having a laterally extending aperture, said apertures being in alignment when said mounting members are attached to said rails and said rails are abutting; and
a locking element insertable into said apertures and operated by a removable key to lock said legs in said closed, non-use position.

10. The combination handle and lock for attachment to a step ladder according to claim 9, characterized further in that said locking element is a push-pin lock having a pin retractably insertable into said aperture of said projection to lock said mounting members and legs together in closed non-use position.

11. The combination handle and lock for attachment to a step ladder according to claim 9 wherein the ladder has rungs extending across said one leg and attached to the rails of said one leg, said combination handle and lock characterized further in that said one of said mounting members is attachable to said one leg, and said handle is on said one mounting member.

12. The combination handle and lock for attachment to a step ladder according to claim 11, characterized further in that said locking element is a push-pin lock having a pin retractably insertable into said aperture of said projection to lock said mounting members and legs together in closed non-use position.

13. A lock for attachment to a step ladder that has a pair of legs, each leg having first and second side rails, each said legs being pivotally connected for pivoting between a spread open use position and a closed non-use position, in which closed position the first and second side rails of one leg abut the first and second side rails of the other leg, and said rails have outer side surfaces, said lock comprising:
a first mounting member attachable to the outer side surface of said first rail of said first leg;
a second mounting member attachable to the outer side surface of said first rail of said second leg for abutting alignment with said first mounting member when said mounting members are attached to said rails;
one of said first and second mounting members having a recess extending into said mounting member from an opening facing for alignment with the other mounting member when said legs are in said closed position;
the other of said first and second mounting members having a projection located and shaped to be received within said recess when said legs are abutting;
said one mounting member having a laterally extending aperture opening into said recess, and said projection having a laterally extending aperture, said apertures being in alignment when said rails are abutting; and
a locking element insertable into said apertures and operated by a removable key to lock said legs in said closed, non-use position.

14. The lock for attachment to a step ladder according to claim 13, characterized further in that said locking element is a push-pin lock having a pin retractably insertable into said aperture of said projection to lock said mounting members and legs together in closed non-use position.

15. The lock for attachment to a step ladder according to claim 13 wherein the ladder has rungs extending across said one leg and attached to the rails of said one leg, said lock characterized further in that said recess extends into said first mounting member; and said projection is on said second mounting member.

16. The lock for attachment to a step ladder according to claim 15, characterized further in that said locking element is a push-pin lock having a pin retractably insertable into said aperture of said projection to lock said mounting members and legs together in closed non-use position.
